(19) United States
(12) Patent Application Publication
(10) Pub. No.: US 2013/0242551 A1
(43) Pub. Date: Sep. 19, 2013

(54) Illuminant with low dazzle

(71) Applicants: Ching-Cherng Sun, Yangmei City (TW); Jung-Hsuan Chang, New Taipei City (TW); Ching-Yi Chen, New Taipei City (TW)

(72) Inventors: Ching-Cherng Sun, Yangmei City (TW); Jung-Hsuan Chang, New Taipei City (TW); Ching-Yi Chen, New Taipei City (TW)

(73) Assignee: National Central University, Zhongli City (TW)

(21) Appl. No.: 13/422,726

(22) Filed: Mar. 16, 2012

(51) Int. Cl. F21V 13/02

(52) U.S. Cl. 362/235; 362/307

(57) ABSTRACT

An illuminant with low dazzle includes a lampshade and an illuminating module. The lampshade has a receiving space, a reflection section and a transmission section. A connection hole is opened on the reflection section. The illuminating module includes at least one light source and a function board. The function board is assembled to the connection hole. The light source is electrically connected to the bottom surface of the function board. Therefore, some light beams from the light source are reflected at the reflection section to the transmission section; the others directly reach to the transmission section. All light beams from the light source are emitting out via transmission section, such that the light beams is not bright enough to make people dazzle but the intensity of the light beams are not influenced by the transmission section.

### BACKGROUND OF THE INVENTION

1. Field of the Invention

The present invention relates to an illuminant, more particularly to an illuminant with low dazzle.

2. Description of Related Art

Most baseball stadiums, gymnasiums, and sport centers provide many illuminants, like searchlights, for the games at night. However, the searchlight transforms a lot of power into illumination for lightening the game. The light beams from the searchlight are often very glaring.

When the audience's eyes get these glaring light beams, it often leads to the visibility of the eyes to disable for a short time, even makes the audience feel faint to miss the critical hit in the games. In order to make audiences enjoy all games at night, the illuminants must provide high intensity light for illuminating the games at night and low dazzle light for the audience to watch more comfortably.

The conventional illuminant usually comprises a light bulb and a reflector. The inner surface of the reflector is composite of many little convex surfaces for reflecting the light beams from the light bulb as far as possible. However, the brightness of the conventional illuminant is too shining to watch for a long time. Some manufacturer provided a transparent plastic, glass or filter in front of the light bulb to solve this problem, but they failed to provide the illumination with enough intensity. How to provide one illuminant with high intensity and low dazzle is necessary in this field.

The present invention has arisen to mitigate and/or obviate the disadvantages of the conventional.

### SUMMARY OF THE INVENTION

The main objective of the present invention is to provide an improved illuminant with low dazzle.

To achieve the objective, an illuminant with low dazzle comprises a lampshade having a receiving space defined therein, the lampshade having a reflection section and a transmission section, the transmission section adjacent to the reflection section, a connection hole opened on the reflection section, the connection hole communicated with the receiving space, an illuminating module placed into the connection hole, the illuminating module comprising at least one light source and a function board, the function board assembled to the connection hole, the light source electrically connected to the bottom surface of the function board, the light source disposed in the receiving space of the lampshade; thereby some light beams from the light source are reflected at the reflection section to the transmission section; the others directly reach to the transmission section; all light beams from the light source are emitting out via transmission section, such that the light beams are not bright enough to make people dazzle but the intensity of the light beams are not influenced by the transmission section.

The reflection section is made from the light-reflecting mirrors or the flawless deflectors to predefine the largest illuminative range for the different environments.

The transmission section is made from the surface-scattering filters or the volume-scattering filters for weakening the brightness of the light beams. The light beams are scattered at the outer surface of the transmission section made from the surface-scattering filters. The light beams are slightly reflected back to the receiving space at the inner surface of the transmission section made from the volume-scattering filters.

The transmission section is formed as a cylinder, a cone or a polyhedron for illuminating the different environments.

The light source is a single light emitting diode or a LED array for illuminating the different environments.

Two imaginary normal lines are respectively defined at two sides of the illuminating module. An angle between the reflection section and the imaginary normal line is θ. The angle θ is between 0°˜140°.

The size of the function board is not smaller than the connection hole.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an illuminant with low dazzle in accordance with the present invention;

FIG. 2 is an exploded view of the illuminant with low dazzle in accordance with the present invention;

FIG. 3 is a front view for showing a light source with a single LED;

FIG. 4 is a front view for showing the light source with a LED array;

FIG. 5 is a front view for showing a transmission section made from the volume-scattering filters;

FIG. 6 is a front view for showing a reflection section made from the light-reflecting mirrors;

FIG. 7 is a perspective view for showing the transmission section to be a cylinder;

FIG. 8 is a perspective view for showing the transmission section to be a cone; and

FIG. 9 is a perspective view for showing the transmission section to be a polyhedron.

### DETAILED DESCRIPTION OF THE INVENTION

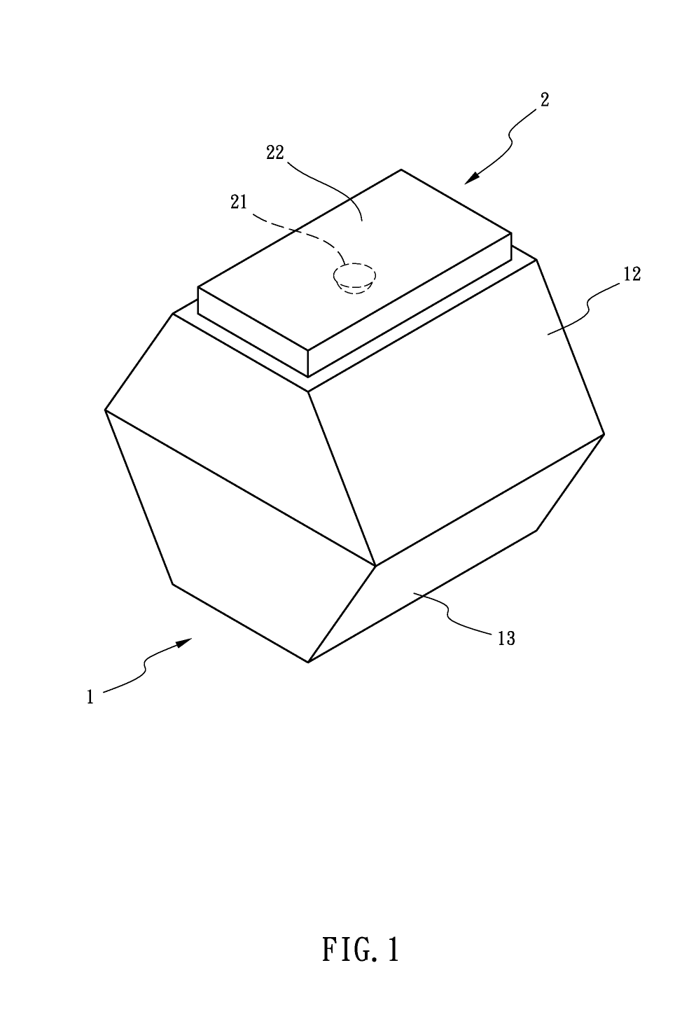

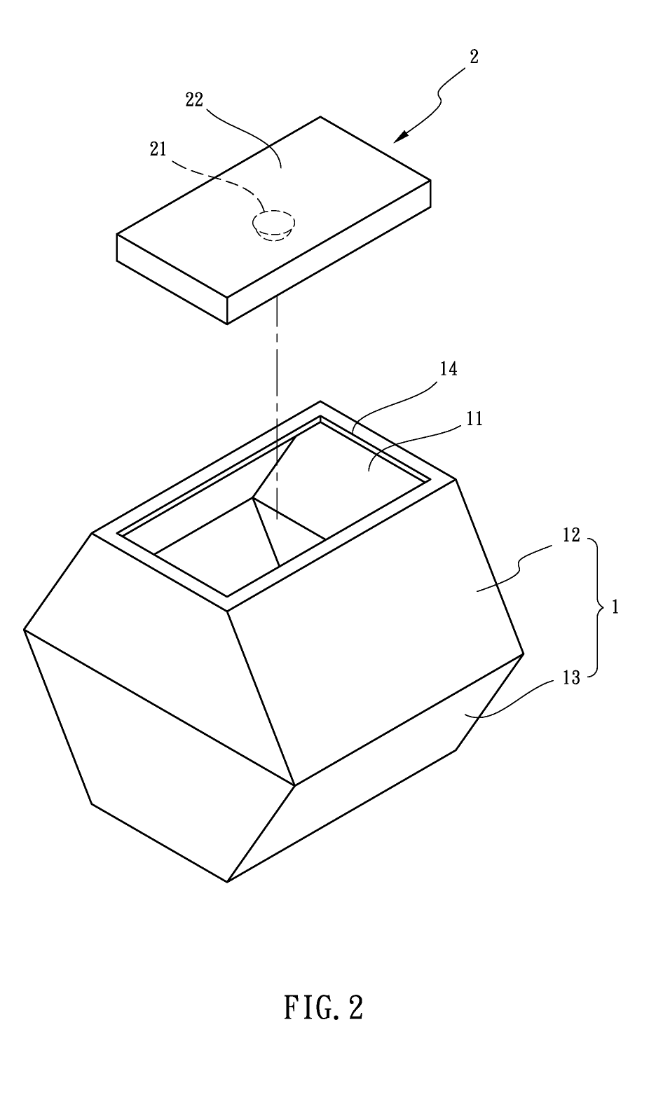

Referring to FIGS. 1-3, an illuminant with low dazzle in accordance with the present invention comprises a lampshade 1 and an illuminating module 2. The lampshade 1 has a receiving space 11 defined therein. The lampshade 1 has a reflection section 12 and a transmission section 13. The transmission section 13 is adjacent to the reflection section 12. A connection hole 14 is opened on the reflection section 12. The connection hole 14 is communicated with the receiving space 11.

The illuminating module 2 is placed into the connection hole 14. The illuminating module 2 comprises at least one light source 21 and a function board 22. The function board 22 is assembled to the connection hole 14. The size of the function board 22 is not smaller than the connection hole 14. The light source 21 is electrically connected to the bottom surface of the function board 22. The light source 21 is disposed in the receiving space 11 of the lampshade 1.

The reflection section 12 is made from the flawless deflectors or the light-reflecting mirrors. Thus, the light beams from the light source 21 are reflected at the flawless deflectors or the light-reflecting mirrors to provide the largest illumination for the different environments like baseball stadiums, gyms or operas. The details are illustrated as following:

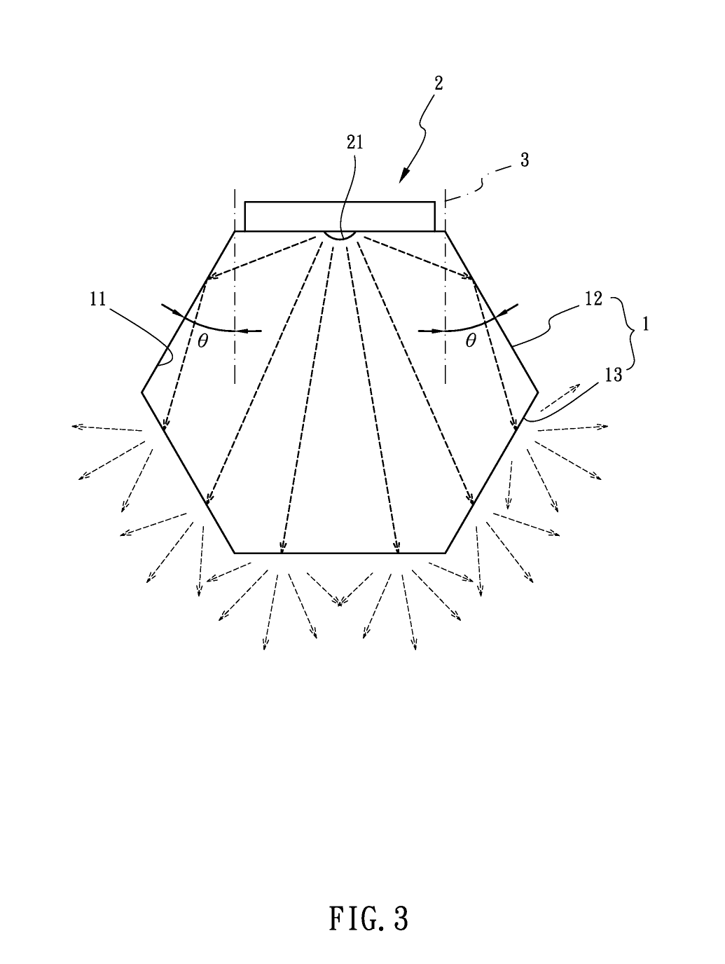

1. Referring to FIGS. 3-5, the arrow dotted lines shows that the light beams are reflected at the flawless deflectors to predefine one suitable illuminative range, and then the light beams are passing through the transmission section 13 for illumination.

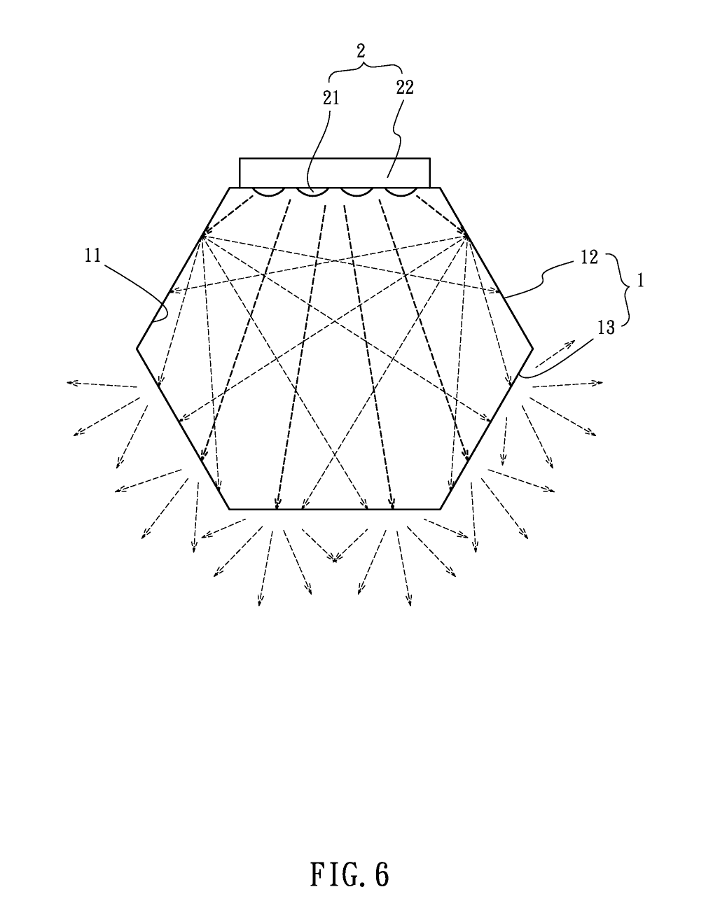

2. Referring to FIG. 6, the arrow dotted lines shows that the light beams are reflected at the light-reflecting mirrors to predefine another suitable illuminative range, and then the light beams are passing through the transmission section 13 for illumination.

Referring to FIG. 3, two imaginary normal lines 3 are respectively defined at two sides of the illuminating module 2. An angle between the reflection section 12 and the imaginary normal line 3 is θ. The angle θ is between 0°˜140° to make sure that the light beams from the light source 21 is reflected on the reflection section 12 and further passing through the transmission section 13.

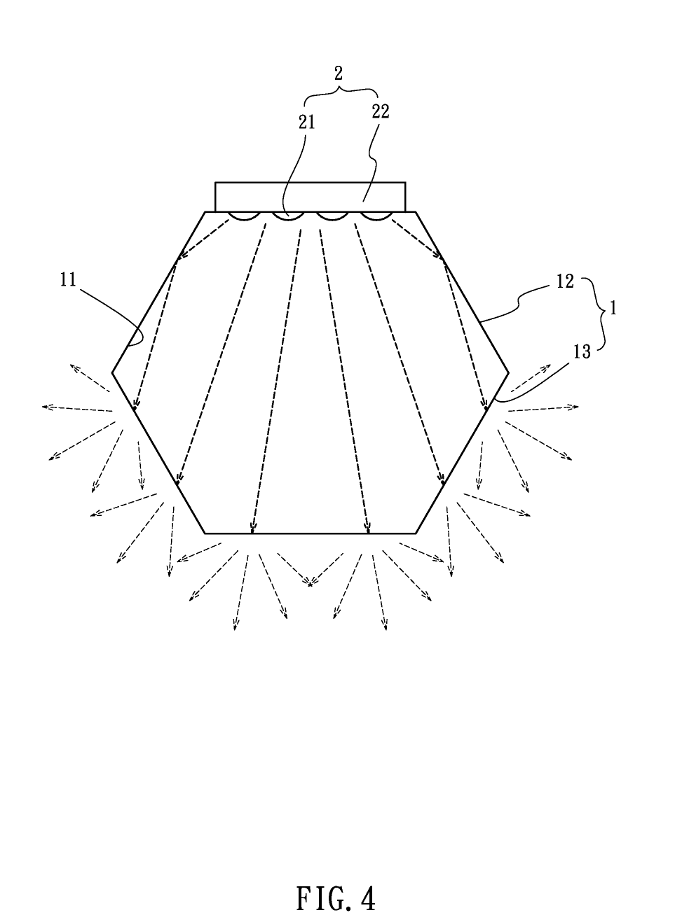

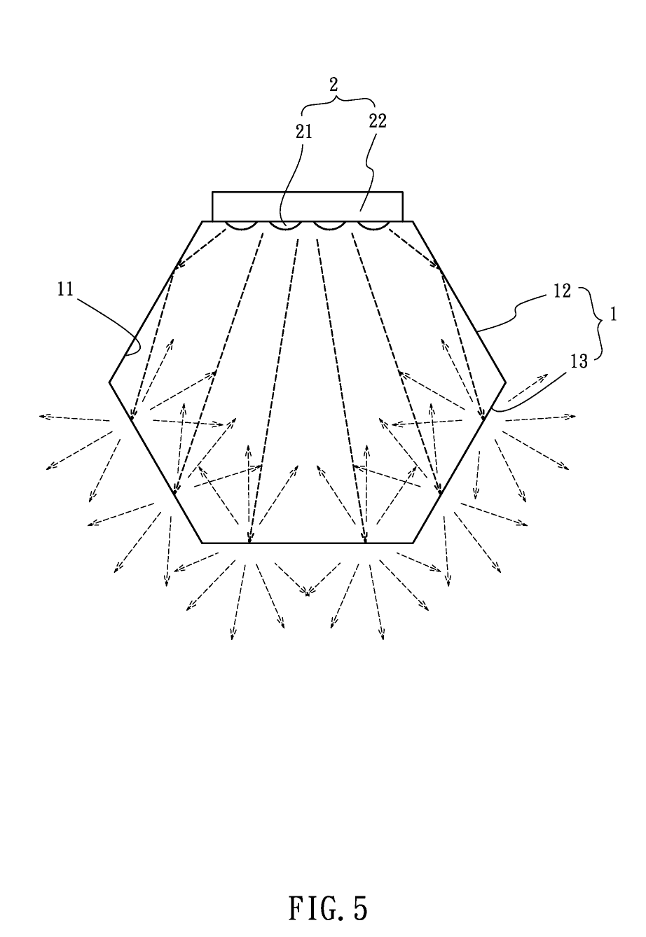

Referring to FIGS. 4-5, the transmission section 13 is made from the surface-scattering filters or the volume-scattering filters for weakening the brightness of the light beams. As shown in FIG. 4, when the light beams from the light source 21 are passing through the transmission section 13 which is made from the surface-scattering filters, the light beams are further scattered at the outer surface of the transmission section 13 to maintain the predefined illuminative range and to decrease the brightness of the light beams. As shown in FIG. 5, when the light beams from the light source 21 are passing through the transmission section 13 which is made from the volume-scattering filters, the light beams are slightly reflected back to the receiving space 11 at the inner surface of the transmission section 13 to decrease the brightness of the light beams but not to influence on the predefined illuminative range.

Under the above arrangement, some light beams from the light source 21 are reflected at the reflection section 12 to the transmission section 13; the others directly reach to the transmission section 13. All light beams from the light source 21 are emitting out via transmission section 13, such that the light beams are not bright enough to make people dazzle, but the intensity of the light beams are not influenced by the transmission section 13.

Referring to FIGS. 3-6, the number of the light sources 21 must increase to illuminate the larger area. The light source 21 is a single light emitting diode or a LED array.

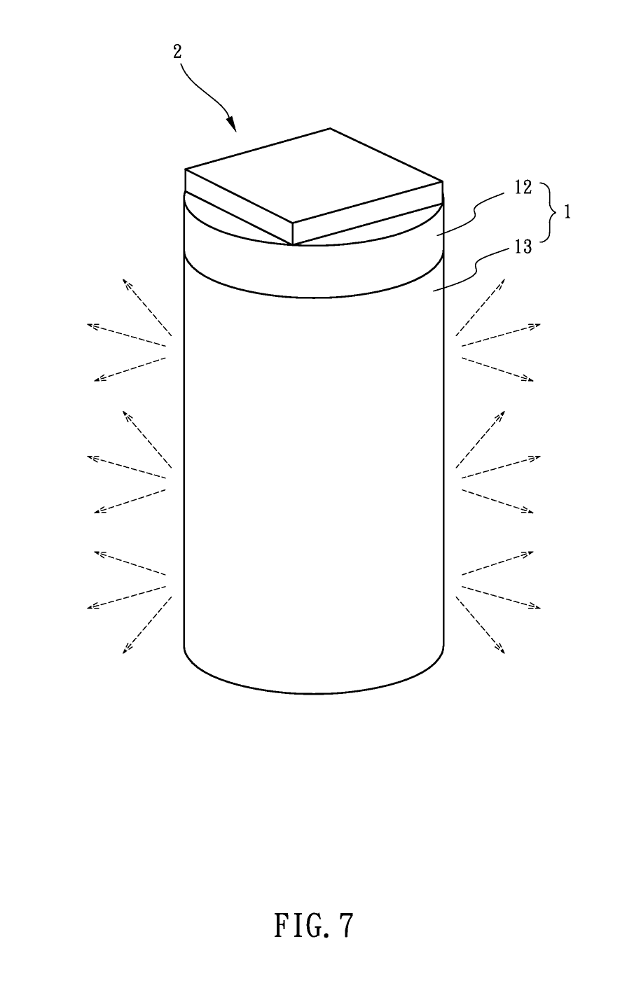

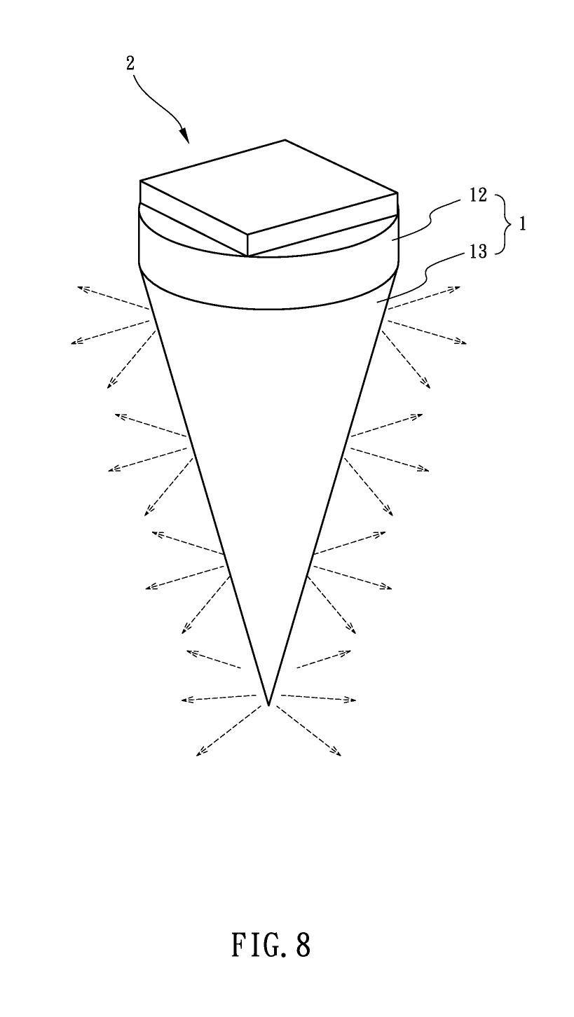

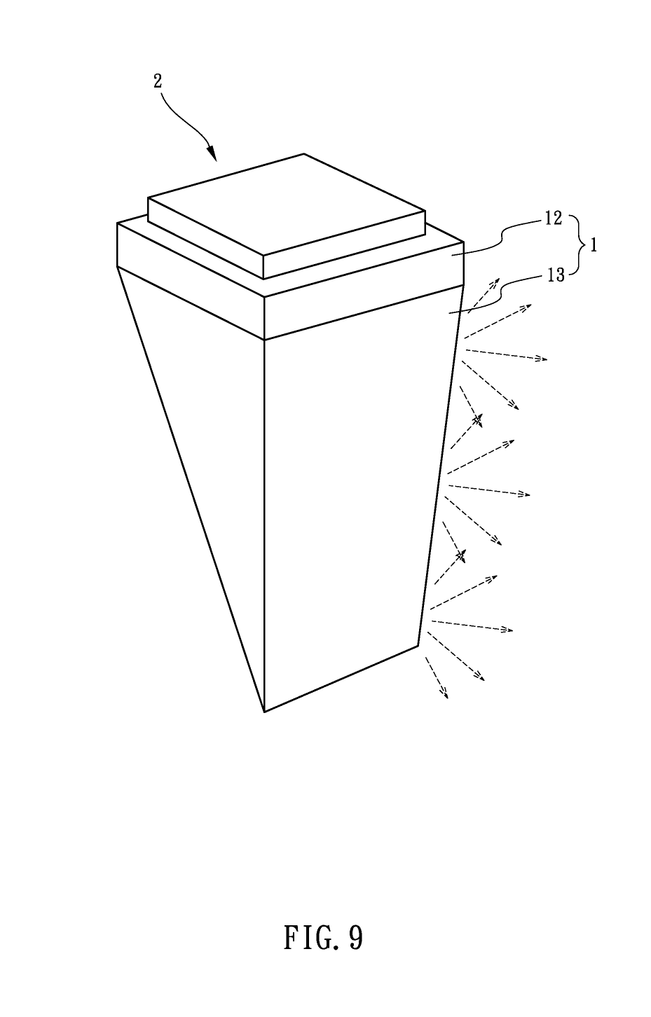

Referring to FIGS. 7-9, the transmission section 13 can be many different shapes, such as a cylinder, a cone or a polyhedron for illuminating the different environments.

Although the invention has been explained in relation to its preferred embodiment, it is to be understood that many other possible modifications and variations can be made without departing from the spirit and scope of the invention as hereinafter claimed.

What is claimed is:

1. An illuminant with low dazzle comprising:
a lampshade having a receiving space defined therein, the lampshade having a reflection section and a transmission section, the transmission section adjacent to the reflection section, a connection hole opened on the reflection section, the connection hole communicated with the receiving space; and
an illuminating module placed into the connection hole, the illuminating module comprising at least one light source and a function board, the function board assembled to the connection hole, the light source electrically connected to the bottom surface of the function board, the light source disposed in the receiving space of the lampshade;
thereby some light beams from the light source are reflected at the reflection section to the transmission section; the others directly reach to the transmission section; all light beams from the light source are emitting out via transmission section, such that the light beams are not bright enough to make people dazzle but the intensity of the light beams are not influenced by the transmission section.

2. The illuminant with low dazzle as claimed in claim 1, wherein the reflection section is made from the light-reflecting mirrors or the flawless deflectors to predefine the largest illuminative range for the different environments.

3. The illuminant with low dazzle as claimed in claim 1, wherein the transmission section is made from the surface-scattering filters or the volume-scattering filters for weakening the brightness of the light beams; the light beams are scattered at the outer surface of the transmission section made from the surface-scattering filters; the light beams are slightly reflected back to the receiving space at the inner surface of the transmission section made from the volume-scattering filters.

4. The illuminant with low dazzle as claimed in claim 1, wherein the transmission section is formed as a cylinder, a cone or a polyhedron for illuminating the different environments.

5. The illuminant with low dazzle as claimed in claim 1, wherein the light source is a single light emitting diode or a LED array for illuminating the different environments.

6. The illuminant with low dazzle as claimed in claim 1, wherein two imaginary normal lines are respectively defined at two sides of the illuminating module; an angle between the reflection section and the imaginary normal line is θ; the angle θ is between 0°˜140°.

7. The illuminant with low dazzle as claimed in claim 1, wherein the size of the function board is not smaller than the connection hole.
